(19) United States
(12) Patent Application Publication
(10) Pub. No.: US 2008/0094577 A1
(43) Pub. Date: Apr. 24, 2008

(54) Time-Multiplexed Led Light Source for Projection Displays

(75) Inventors: Marcellinus Petrus Carolus Michael Krijn, Eindhoven (NL); Siebe Tjerk De Zwart, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,923

(22) PCT Filed: Jul. 21, 2005
(86) PCT No.: PCT/IB05/52453

§ 371 Date: Jan. 30, 2007

(30) Foreign Application Priority Data
Aug. 2, 2004 (EP) 04103718.5

(51) Int. Cl. G03B 21/28; G03B 21/14

(52) U.S. Cl. 353/20

(57) ABSTRACT

A light source device for projection displays is disclosed, comprising a plurality of Light Emitting Diode (LED) devices. The plurality of LED devices are arranged to sequentially operate. A light combining means are arranged to convey light from the LED devices to a light output of the light source. The light combining means comprises controllable polarisation means arranged such that the light is polarized by a structure of the light combining means. Further, a projection display system comprising a projection lens, a controller, and an image generating means, using the light source above is disclosed.

### FIELD OF INVENTION

The present invention relates to a light source for a projection display system, and particularly to a light source using sequentially operating light emitting diodes.

### BACKGROUND OF THE INVENTION

It is an aim to use light emitting diodes (LEDs) as light source for projection displays due to small size, high durability, and long life of LEDs. However, in projection displays, brightness of the light source is crucial for the image quality and the usability of the projection system for different environments.

In US 2003/0218723 A1, it is disclosed that the emission output of a LED drops due to heating of the LED during operation. This reduces the brightness of the light source either by implying operation at lower power, or by reduced emission as the light source is heated. In US 2003/0218723 A1, this is solved by introducing a non-emission time for each LED by placing the LEDs on a movable section, wherein the LEDs are in an illumination state during a shorter period when in illumination position with respect to the movable section, and in a non-illumination state when in a non-illumination position with respect to the movable section. Thus, the LEDs are not heated to such an extent that the light emission drops significantly.

A problem with the solution disclosed in US 2003/0218723 A1 is that the movable parts imply a plurality of mechanical constraints. Further, production of mechanically complex moving structures also imply a problem. Summing up, a problem with the prior art solution is the provision of mechanically moving parts.

### SUMMARY OF THE INVENTION

It is an object of the present invention to provide a bright light source without mechanically moving parts.

The above object is achieved according to a first aspect of the present invention by a light source device for projection displays, comprising a plurality of Light Emitting Diode (LED) devices. The plurality of LED devices are arranged to sequentially operate. Light combining means are arranged to convey light from the LED devices to a light output of the light source. The light combining means comprises controllable polarisation means arranged such that the light is polarized by a structure of the light combining means.

Sequential operation of LED devices means that one or more LED devices are switched off while one or more other LED devices are switched on at a time instant to allow LED devices to work with a duty cycle that is lower than 50%, depending on the number of redundant LED devices. This will allow LED devices to cool down during off-state, which will improve light emission during on-state.

A LED device may comprise one or more LEDs. Light combining means are a structure without moving parts that enable conveying light from LED devices that are active.

The controllable polarisation means may comprise a switchable retarder. The switchable retarder may comprise a liquid crystal cell.

The light combining means may comprise a polarization conversion system and/or a polarizing beam splitter.

A polarization conversion system is a structure for directing all light in one direction, with a uniform polarization.

A polarizing beam splitter is a structure that will transmit the p-polarized light and reflect the s-polarized light component in a perpendicular direction.

The light source device may be configured such that a first LED device is arranged on a first side of a first polarizing beam splitter, a second LED device is arranged on a second side of the polarizing beam splitter perpendicular to the first side of the polarizing beam splitter, and a first controllable polarizer is arranged on a third side of the polarizing beam splitter opposite to the first side of the first polarizing beam splitter.

The light source device may further be configured such that a second controllable polarizer is arranged on a fourth side of the first polarizing beam splitter opposite to the second side of the first polarizing beam splitter, a second polarizing beam splitter is arranged next to the second controllable polarizer, and a third controllable polarizer is arranged on a second side of the second polarizing beam splitter perpendicular to a side of the second polarizing beam splitter facing the second controllable polarizer, wherein the third controllable polarizer is arranged to convert s-polarized light to p-polarized light when the first LED device is active, and the first and third controllable polarizers are arranged to convert s-polarized light to p-polarized light when the second LED device is active, and the second controllable polarizer is arranged to convert p-polarized light to s-polarized light when the second LED device is active.

The light source device may further be configured such that a third polarizing beam splitter is arranged next to the first controllable polarizer, wherein a third LED device is arranged on a side of the third polarizing beam splitter perpendicular to a first side of the third polarizing beam splitter facing the first controllable polarizer, a fourth controllable polarizer is arranged on a second side of the third polarizing beam splitter perpendicular to a side of the third polarizing beam splitter facing the first controllable polarizer, a fifth controllable polarizer is arranged on a side of the third polarizing beam splitter opposite to the first side of the third polarizing beam splitter, a fourth polarizing beam splitter is arranged next to the third and fourth controllable polarizers, and a sixth controllable polarizer is arranged on a side of the fourth polarizing beam splitter perpendicular to a side of the fourth polarizing beam splitter facing the fourth controllable polarizer and opposite to a side of the fourth polarizing beam splitter facing the third controllable polarizer, wherein the third controllable polarizer is active when the first LED device is active, the first, second, and third controllable polarizers are active when the second LED device is active, and the fourth, fifth, and sixth controllable polarizers are active when the third LED device is active.

An active controllable polarizer is arranged to convert p-polarized light to s-polarized light, and s-polarized light to p-polarized light.

The light source device may also be configured such that a second polarizing beam splitter is arranged next to the controllable polarizer, wherein a third LED device is arranged on a side of the second polarizing beam splitter perpendicular to a first side of the second polarizing beam splitter facing the first controllable polarizer, and a second controllable polarizer is arranged on a side of the second polarizing beam splitter opposite to the first side of the second polarizing beam splitter, wherein the first controllable polarizer is arranged to convert s-polarized light to p-polarized light when the second LED device is active and the second controllable polarizer is arranged to convert s-polarized light to p-polarized light when the third LED device is active.

The light combining means may comprise a light guide arranged along the plurality of LED devices, wherein the controllable polarizer may be arranged between the LED devices and the light guide, and a reflective polarizer may be arranged along the light guide, between the controllable polarizer and the LED devices. The light combining means may further comprise a reflective layer arranged along the light guide opposite to the LED devices. A section of the controllable polarizer corresponding to an active LED device may be arranged to convert polarization of light.

The above object is achieved according to a second aspect of the present invention by a projection display system comprising a projection lens, a controller, and an image generating means, using a light source according to the first aspect of the present invention.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 shows a projection display system;

FIG. 2 shows a light source according to one embodiment of the present invention;

FIG. 3 shows an alternative light source according to the present invention;

FIG. 4 shows a light source according to a further embodiment of the present invention;

FIG. 5 shows a light source according to a further embodiment of the present invention;

FIG. 6 shows a light source according to a further embodiment of the present invention;

FIG. 7 shows a polarization conversion system;

FIG. 8 shows an alternative polarization conversion system;

FIG. 9 shows a light source according to a further embodiment of the present invention; and

FIG. 10 shows a light source according to a further embodiment of the present invention.

### DETAILED DESCRIPTION OF PREFERRED EMBODIMENTS

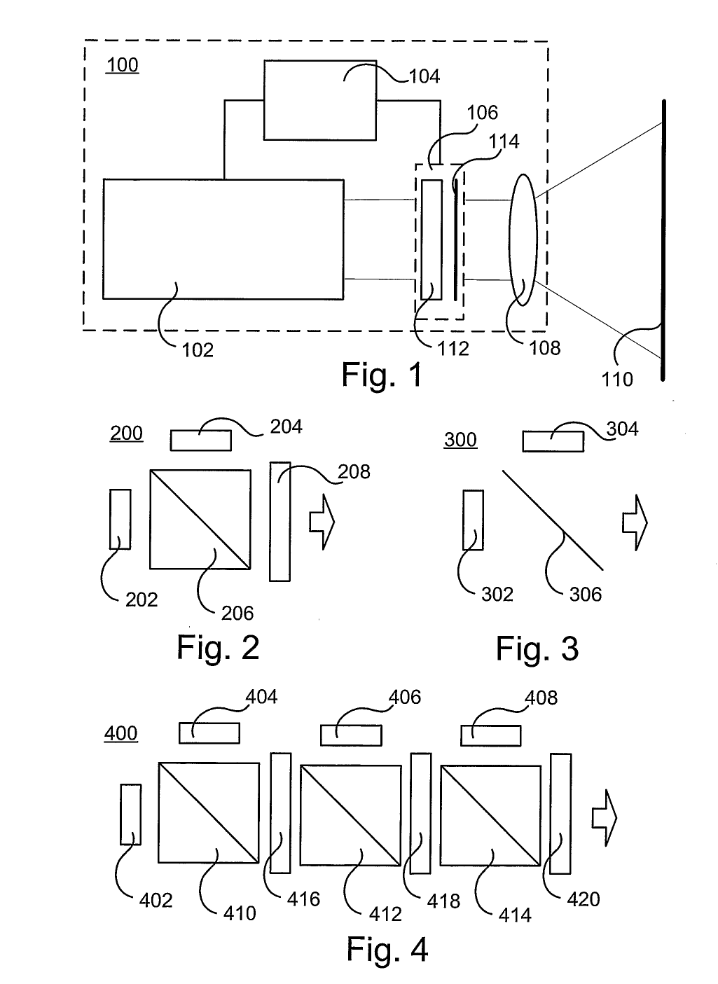

FIG. 1 shows a projection display system 100 comprising a light source 102, a controller 104, an image generating means 106, and a projection lens 108. The projection display system 100 projects an image on a screen 110. The image generating means 106 preferably comprises a liquid crystal panel 112 and an analyzer 114. The light source 102 provides polarized light to the liquid crystal panel 112 of the image generating means 106. The liquid crystal panel 112 modulates the light in a plurality of pixels. It is an effect of the liquid crystal panel 112 that light of the modulated pixels will change polarization, while non-modulated pixels will not. Therefore, the analyzer 114 is a polarizing filter with a polarization direction for transmission that is perpendicular to the polarization direction of the light illuminating the liquid crystal panel 112 and will cancel light from non-modulated pixels to improve definition of the image. The controller 104 controls light generation of the light source 102, and image generation of the image generating means 106. For example, the controller can control sequential colour divided image generation, where the red, green, and blue image is generated sequentially, and displayed rapidly, such that a viewer experiences a full-colour image.

For producing a large projected image, that can be viewed also in daylight, the brightness of the light source is crucial. To improve the brightness of the LEDs used in the light source 102, the LEDs are only driven with a low duty cycle, to avoid the effects of decrease of light emission as the LEDs get hot. Instead, the LEDs are driven sequentially, to let the LEDs have a period of off-state. Thereby, the emission of the LEDs can be improved significantly during on-state.

FIG. 2 shows a light source 200 comprising a first LED device 202 and a second LED device 204. The LED devices 202, 204 are arranged to alternately emit light to enable an improved emission. A polarizing beam splitter (PBS) 206 is arranged to direct polarized light from the LED devices 202, 204 towards a light output of the light source. The LED devices 202, 204 produce unpolarized light, i.e. light polarized in both s-state and p-state. When the first LED device 202 emits light, unpolarized light is emitted to the PBS 206. The PBS will transmit the p-polarized light towards the light output and reflect the s-polarized light component (downwards in FIG. 2). Similarly, when the second LED device 204 emits light, unpolarized light is emitted to the PBS 206. The PBS will transmit the p-polarized light (downwards in FIG. 2) and reflect the s-polarized light component towards the light output. Thus is p-polarized light provided when the first LED device 202 is active, and s-polarized light when the second LED device is active. To achieve a uniformly polarized light output, a switchable retarder 208 is provided. The switchable retarder 208 rotates the polarization of linearly polarized light from p-state to s-state and vice versa when in an on-state. Thus, uniformly polarized light can be achieved at the output of the light source 200 by activating the switchable retarder 208 when the second LED device 204 is active, and deactivating the switchable retarder 208 when the first LED device 202 is active. Thus is p-polarized light achieved. It is also possible to achieve s-polarized light by activating the switchable retarder 208 when the first LED device 202 is active, and deactivating the switchable retarder 208 when the second LED device 204 is active.

For some applications, there is no need for polarized light. Then, a switchable mirror 306 can be used instead of a PBS, as is shown in FIG. 3. A light source 300 then comprises a first LED device 302, a second LED device 304, and the switchable mirror 306 to provide unpolarized light at an output of the light source 300. The switchable mirror 306 is operated to reflect the light from the second LED device 304 when active, and to transmit light from the first LED device 302 when active, towards the output of the light source 300.

FIG. 4 shows a light source 400 comprising a plurality of LED devices 402, 404, 406, 408. The LED devices 402, 404, 406, 408 are arranged to alternately emit light to enable an improved emission. A plurality of polarizing beam splitters (PBSs) 410, 412, 414 are arranged to direct polarized light from the LED devices 402, 404, 406, 408 towards a light output of the light source. A plurality of switchable retarders 416, 418, 420 are provided to achieve uniformly polarized light at the output of the light source 400.

To achieve p-polarized light at the output, the switchable retarders 416, 418, 420 are in off-state when the first LED device 402 is active, the first switchable retarder 416 is in on-state when the second LED device 404 is active, while the other switchable retarders 418, 420 are in off-state. Similarly, when the third LED device 406 is active, the second switchable retarder 418 is in on-state, while the other switchable retarders 416, 420 are in off-state, and when the fourth LED device 408 is active, the third switchable retarder 420 is in on-state, while the other switchable retarders 416, 418 is in off-state. Thus, a lower duty-cycle is achieved. The number of alternating LED devices can be arbitrary by this structure, where more alternating LED devices result in a lower duty-cycle, which implies lower temperature of the LED devices, which improves light emission.

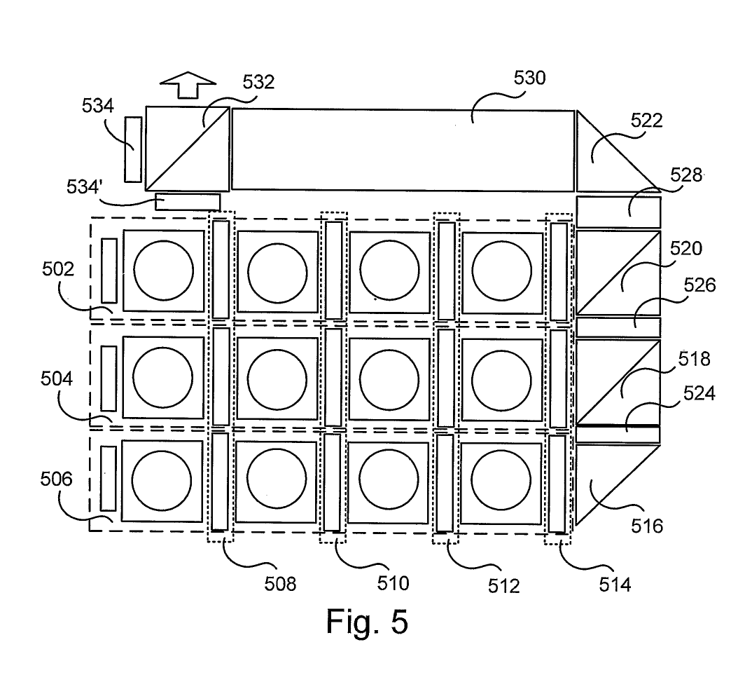

FIG. 5 shows one embodiment of a light source according to the present invention. The light source comprises banks of light sources 502, 504, 506 similar to the light source of FIG. 4. Each of the banks 502, 504, 506 provide a color, e.g. bank 502 provides red, bank 504 provides green, and bank 506 provides blue light. Each of the banks 502, 504, 506 comprises a plurality of LEDs, a plurality of PBSs to direct the light, and a plurality of switchable retarders to get the right polarization of the light. The switchable retarders are preferably arranged in groups 508, 510, 512, 514 for better control, production and cost. A retarder group 508, 510, 512, 514 is preferably made of a single piece that is segmented in three parts. The light from the light source banks 502, 504, 506 are directed by light linking means 516, 518, 520, 522, and light guides 524, 526, 528, 530 to a PBS 532. The light that reaches the PBS 532 which is p-polarized will thus be transmitted to a liquid crystal on silicon (LCOS) device 534, which will change the polarization to s-state and reflect the light back to the PBS 532, which will transmit the light towards the output of the light source. It should be noted that it is advantageous if the area of the LCOS device 534 facing the PBS 532 is smaller than the corresponding area of the PBS 532. This will avoid that light hits the borders of the PBS 532, which will degrade image quality. To ensure that no light hits the border areas of the PBS 532, a mask (not shown) can be inserted between the LCOS device 534 and the PBS 532. It should also be noted that it can be advantageous to position the LCOS device 534′ on another side of the PBS 532 such that it requires illumination with s-polarized light. In this case, the switchable retarders 514 are used to ensure that only s-polarized light can leave each of the banks 502, 504, 506. It should also be noted that it can be advantageous to insert additional passive optical elements, such as lenses (not shown), in between light guide 530 and PBS 532 and in between LCOS device 534 and PBS 532, or alternatively between LCOS device 534′ and PBS 532.

The embodiment is shown by example only with three colours, but can be used for any number of colours.

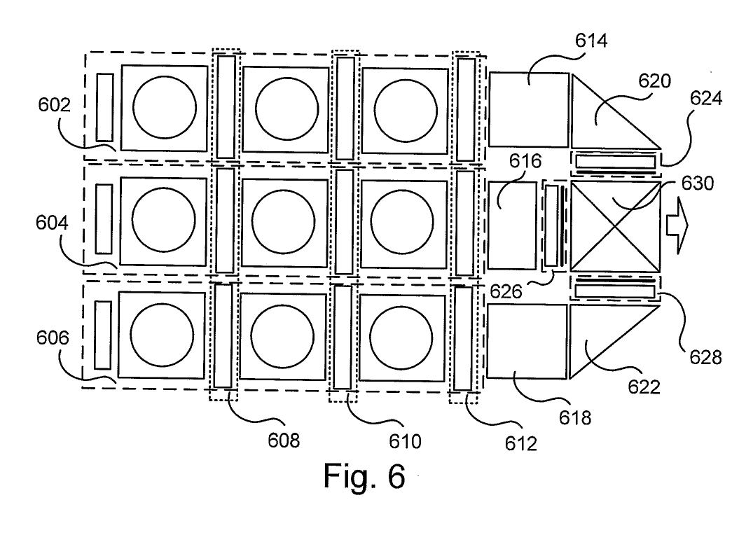

FIG. 6 shows another embodiment of a light source and image generator according to the present invention, where light is generated in banks of light sources 602, 604, 606, each similar to the one in FIG. 4. Each of the banks 602, 604, 606 provide a color, e.g. bank 602 provides red, bank 604 provides green, and bank 606 provides blue light. Each of the banks 602, 604, 606 comprises a plurality of LEDs, a plurality of PBSs to direct the light, and a plurality of switchable retarders to get the right polarization of the light. The switchable retarders are preferably arranged in groups 608, 610, 612 for better control, production and cost. A retarder group 608, 610, 612 is preferably made of a single piece that is segmented in three parts. The light from the light source banks 602, 604, 606 are directed by light guides 614, 616, 618 and light guiding means 620, 622 to image generating means 624, 626, 628, respectively. The light generating means preferably comprise a liquid crystal panel and an analyzer. The light source banks 602, 604, 606 provide polarized light to the liquid crystal panels of the image generating means 624, 626, 628. The liquid crystal panels modulate the light in a plurality of pixels. It is an effect of the liquid crystal panels that light of the modulated pixels will change polarization, while non-modulated pixels will not. Therefore, the analyzers are polarizing filters with a polarization direction for transmission that is perpendicular to the polarization direction of the light illuminating the liquid crystal panels and will cancel light from non-modulated pixels to improve definition of the image. For example, red light from light source bank 602 is provided to image generating means 624 to generate the red component of the colour image, green light from light source bank 604 is provided to image generating means 626 to generate the green component of the colour image, and blue light from light source bank 606 is provided to image generating means 628 to generate the blue component of the colour image. The image components are combined by a cross prism 630 and output to a projection lens (not shown).

It should be noted that it is advantageous if the area of the image generating means 624, 626, 628 facing the cross prism 630 is smaller than the corresponding areas of the cross prism 630. This will avoid that light hits the borders of the cross prism 630, which will degrade image quality. To ensure that no light hits the border areas of the cross prism 630, masks (not shown) can be inserted between the image generating means 624, 626, 628 and the cross prism 630.

The embodiment is shown by example only with three colours, but can be used for any number of colours.

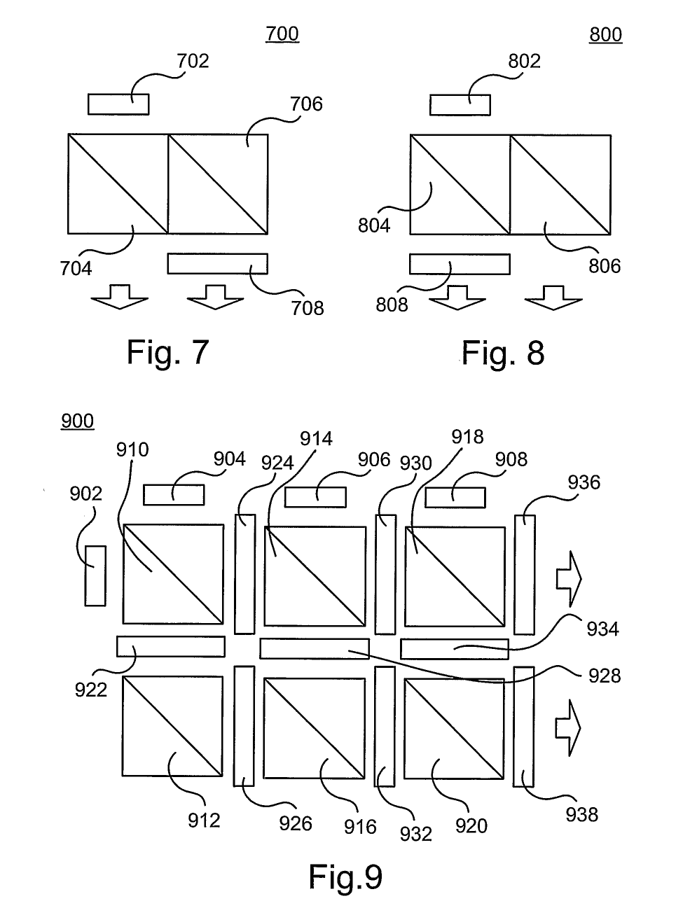

Approximately half of the light is lost from each LED device by reflecting the s-polarized part of the unpolarized light in the PBSs, such that it does not reach the outout of the light source. FIG. 7 shows a structure, called a polarisation conversion system (PCS), for directing all light in one direction, with a uniform polarization. The structure 700 comprises a LED device 702, a first PBS 704, a second PBS 706, and a retarder 708. The LED device 702 emits unpolarized light to the first PBS 704, which transmits p-polarized light to an output and reflects s-polarized light to the second PBS 706. The second PBS 706 reflects the s-polarized light to the retarder 708, which converts the light to p-state. Thus, all light is output as p-polarized light.

FIG. 8 shows a similar structure as FIG. 7 for directing all light in one direction, with a uniform polarization. The structure 800 comprises a LED device 802, a first PBS 804, a second PBS 806, and a retarder 808. The LED device 802 emits unpolarized light to the first PBS 804, which transmits p-polarized light to the retarder 808 which converts the light to s-state before output, and reflects s-polarized light to the second PBS 806. The second PBS 806 reflects the s-polarized light to the output. Thus, all light is output as s-polarized light.

The effect of the polarization conversion system structure can be used in the present invention by modifying the light source structures shown in FIGS. 2 and 4 to 6. FIG. 9 shows an embodiment of a light source 900 according to the present invention, where the effect of the polarization conversion system is used. The light source 900 comprises a plurality of LED devices 902, 904, 906, 908. The LED devices 902, 904, 906, 908 are arranged to alternately emit light to enable an improved emission. A plurality of polarizing beam splitters (PBSs) 910, 912, 914, 916, 918, 920 are arranged to direct polarized light from the LED devices 902, 904, 906, 908 towards a light output of the light source. A plurality of switchable retarders 922, 924, 926, 928, 930, 932, 934, 936, 938 are provided to achieve uniformly polarized light at the output of the light source 900.

When the first LED device 902 is active, it emits unpolarized light to the first PBS 910, which reflects s-polarized light through the first switchable retarder 922, which is in off-state, to the second PBS 912, and transmits the p-polarized light all way to the output through the PBSs 914, 918 and the switchable retarders 924, 930, 936, which are in off-state. The s-polarized light is reflected in the second PBS 912 to the third switchable retarder 926, which is in on-state. Thus, the light is converted to p-state and is thus transmitted to the output through PBSs 916, 920 and switchable retarders 932, 938, which are in off-state.

When the second LED device 904 is active, it emits unpolarized light to the first PBS 910, which reflects s-polarized light through the second switchable retarder 924, which is in on-state and thus converts the light to p-state, to the third PBS 914, and transmits the p-polarized light all way to the output through the PBS 918 and the switchable retarders 930, 936, which are in off-state. The p-polarized light is converted to s-state in the first switchable retarder 922, and is then reflected in the second PBS 912 to the third switchable retarder 926, which is in on-state. Thus, the light is converted to p-state and is thus transmitted to the output through PBSs 916, 920 and switchable retarders 932, 938, which are in off-state.

When the third LED device 906 is active, it emits unpolarized light to the third PBS 914, which reflects s-polarized light through the fifth switchable retarder 930, which is in on-state and thus converts the light to p-state, to the fifth PBS 918, which transmits the p-polarized light to the output through the switchable retarder 936, which is in off-state. The p-polarized light is converted to s-state in the fourth switchable retarder 928, and is then reflected in the fourth PBS 916 to the sixth switchable retarder 932, which is in on-state. Thus, the light is converted to p-state and is thus transmitted to the output through PBS 920 and switchable retarder 938, which is in off-state.

When the fourth LED device 908 is active, it emits unpolarized light to the fifth PBS 918, which reflects s-polarized light through the eighth switchable retarder 936, which is in on-state and thus converts the light to p-state, to the output. The p-polarized light is converted to s-state in the seventh switchable retarder 934, and is then reflected in the sixth PBS 920 to the ninth switchable retarder 938, which is in on-state. Thus, the light is converted to p-state and is thus transmitted to the output.

Similar structure can be used for the multi-colour systems described in connection to FIGS. 5 and 6, with one structure 900 for each colour. The embodiment can be used for any number of colours.

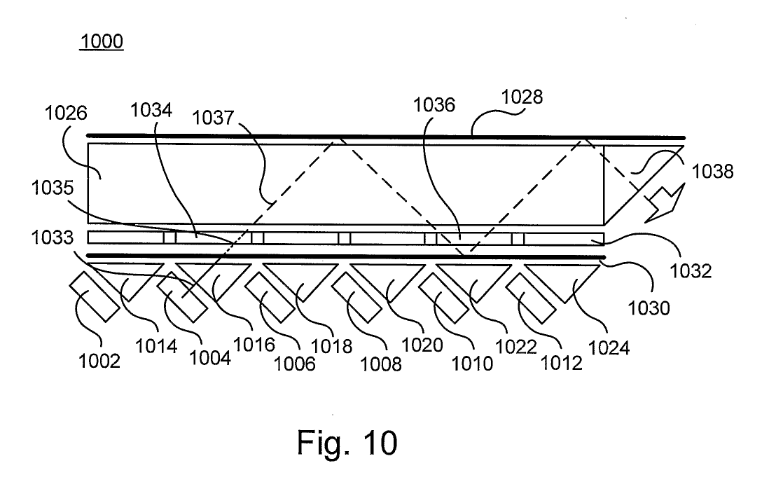

FIG. 10 shows a light source 1000 according to a further embodiment of the present invention. The light source 1000 comprises a plurality of LED devices 1002, 1004, 1006, 1008, 1010, 1012, arranged to alternately emit light to enable an improved emission, a plurality of prisms 1014, 1016, 1018, 1020, 1022, 1024 for coupling light from the LED devices 1002, 1004, 1006, 1008, 1010, 1012 to a light guide 1026 reaching along the LED devices 1002, 1004, 1006, 1008, 1010, 1012 with their prisms 1014, 1016, 1018, 1020, 1022, 1024. For small in-coupling angles, the conditions for total internal reflection may not be fulfilled. To overcome this, a reflective layer 1028 is provided on the light guide 1026 on the opposite side to the LED devices 1002, 1004, 1006, 1008, 1010, 1012 with their prisms 1014, 1016, 1018, 1020, 1022, 1024. Between the LED devices 1002, 1004, 1006, 1008, 1010, 1012 with their prisms 1014, 1016, 1018, 1020, 1022, 1024 and the light guide there is provided a reflective polarizer 1030 having the properties that it will transmit one polarizing component of light and reflect the perpendicular polarizing component. Between the reflective polarizer 1030 and the light guide is a switchable retarder 1032 provided. The switchable retarder 1032 is segmented such that for each LED device it has an independently switchable region. When operating, the region of the switchable retarder 1032 that correspond to an active LED device is in on-state, and others are in off state. Thus, of unpolarized light 1033 from the active LED device, e.g. LED device 1004 as depicted in FIG. 10, that reaches the reflective polarizer 1030, only light 1035 with a certain polarization, e.g. s-polarization, will pass the reflective polarizer 1030. The region 1034 of the switchable retarder 1032 is in on-state, and will convert the s-polarized light 1035 to p-polarized light 1037. The light is then reflected by the reflective layer 1028, or by total internal reflection, in the light guide 1026. The light may transmit through another region 1036, which is in off-state, of the switchable retarder 1032 and be reflected back into the light guide 1026 by the reflective polarizer 1030, since the light is p-polarized and the reflective polarizer 1030 in this example is arranged to reflect p-polarized light. Finally, eventually after further reflections, the light, which maintains its polarization, will reach an output prism 1038 of the light source 1000 and be outputted.

The embodiment can be used for any number of colours by arranging one structure 1000 for each colour. An advantageous feature of this embodiment is that a large, flat switchable retarder with the independently switchable regions arranged in a matrix can be used. This will enable easier production and lower costs.

1. A light source device (102, 200, 400, 500, 600, 900, 1000) for projection displays, comprising a plurality of Light Emitting Diode (LED) devices (202, 204, 402, 404, 406, 408, 902, 904, 906, 908, 1002, 1004, 1006, 1008, 1010, 1012), wherein said plurality of LED devices (202, 204, 402, 404, 406, 408, 902, 904, 906, 908, 1002, 1004, 1006, 1008, 1010, 1012) are arranged to operate sequentially, and a light combining means for conveying light from said LED devices to an output of said light source (102, 200, 400, 500, 600, 900, 1000), characterized in that said light combining means further comprises a controllable polarisation means (208, 416, 418, 418, 420, 508, 510, 512, 514, 608, 610, 612, 922, 924, 926, 928, 930, 932, 934, 936, 938, 1032) arranged such that said light is polarized by a structure of said light combining means.

2. The light source device according to claim 1, wherein said controllable polarisation (208, 416, 418, 418, 420, 508, 510, 512, 514, 608, 610, 612, 922, 924, 926, 928, 930, 932, 934, 936, 938, 1032) means comprises a switchable retarder.

3. The light source device according to claim 2, wherein said switchable retarder comprises a liquid crystal cell.

4. The light source device according to claim 1, wherein said light combining means comprises a polarization conversion system (700, 800, 900).

5. The light source device according to claim 1, wherein said light combining means further comprises a polarizing beam splitter (206, 410, 412, 414, 532, 910, 912, 914, 916, 918, 920).

6. The light source device according to claim 5, wherein a first LED device (202, 402, 902) is arranged on a first side of a first polarizing beam splitter (206, 410, 910), a second LED device (204, 404, 904) is arranged on a second side of said polarizing beam splitter (206, 410, 910) perpendicular to said first side of said polarizing beam splitter (206, 410, 910), and a first controllable polarizer (208, 416, 924) is arranged on a third side of said polarizing beam splitter (206, 410, 910) opposite to said first side of said first polarizing beam splitter (206, 410, 910).

7. The light source device according to claim 6, wherein a second controllable polarizer (922) is arranged on a fourth side of said first polarizing beam splitter (910) opposite to said second side of said first polarizing beam splitter (910), a second polarizing beam splitter (912) is arranged next to said second controllable polarizer (922), and a third controllable polarizer (926) is arranged on a second side of said second polarizing beam splitter (912) perpendicular to a side of said second polarizing beam splitter (912) facing said second controllable polarizer (922), wherein said third controllable polarizer (926) is arranged to convert s-polarized light to p-polarized light when said first LED device (902) is active, and said first and third controllable polarizers (924, 926) are arranged to convert s-polarized light to p-polarized light when said second LED device (904) is active, and said second controllable polarizer (922) is arranged to convert p-polarized light to s-polarized light when said second LED device (904) is active.

8. The light source device according to claim 7, wherein a third polarizing beam splitter (914) is arranged next to said first controllable polarizer (924), wherein a third LED device (906) is arranged on a side of said third polarizing beam splitter (914) perpendicular to a first side of said third polarizing beam splitter (914) facing said first controllable polarizer (924), a fourth controllable polarizer (928) is arranged on a second side of said third polarizing beam splitter (914) perpendicular to a side of said third polarizing beam splitter (914) facing said first controllable polarizer (924), a fifth controllable polarizer (930) is arranged on a side of said third polarizing beam splitter (914) opposite to said first side of said third polarizing beam splitter (914), a fourth polarizing beam splitter (916) is arranged next to said third and fourth controllable polarizers (926, 928), and a sixth controllable polarizer (932) is arranged on a side of said fourth polarizing beam splitter (916) perpendicular to a side of said fourth polarizing beam splitter (916) facing said fourth controllable polarizer (928) and opposite to a side of said fourth polarizing beam splitter (916) facing said third controllable polarizer (926), wherein said third controllable polarizer (926) is active when said first LED device (902) is active, said first, second, and third controllable polarizers (922, 924, 926) are active when said second LED device (904) is active, and said fourth, fifth, and sixth controllable polarizers (928, 930, 932) are active when said third LED device (906) is active.

9. The light source device according to claim 6, wherein a second polarizing (412) beam splitter is arranged next to said controllable polarizer (416), wherein a third LED device (406) is arranged on a side of said second polarizing beam splitter (412) perpendicular to a first side of said second polarizing beam splitter (412) facing said first controllable polarizer (416), and a second controllable polarizer (418) is arranged on a side of said second polarizing beam splitter (412) opposite to said first side of said second polarizing beam splitter (412), wherein said first controllable polarizer (416) is arranged to convert s-polarized light to p-polarized light when said second LED device (404) is active and said second controllable polarizer (418) is arranged to convert s-polarized light to p-polarized light when said third LED device (406) is active.

10. The light source device according to claim 1, wherein said light combining means comprises a light guide (1026) arranged along said plurality of LED devices (1002, 1004, 1006, 1008, 1010, 1012), wherein said controllable polarizer (1032) is arranged between said LED devices (1002, 1004, 1006, 1008, 1010, 1012) and said light guide (1026), and a reflective polarizer (1030) is arranged along said light guide (1026), between said controllable polarizer (1032) and said LED devices (1002, 1004, 1006, 1008, 1010, 1012).

11. The light source device according to claim 10, wherein said light combining means further comprises a reflective layer (1028) arranged along said light guide (1026) opposite to said LED devices (1002, 1004, 1006, 1008, 1010, 1012).

12. The light source device according to claim 10, wherein a section of said controllable polarizer corresponding to an active LED is arranged to convert polarization of light.

13. A projection display system (100) comprising a projection lens (108), a controller (104), and an image generating means (106, 624, 626, 628), characterized in that the projection system further comprises a light source (102, 200, 400, 500, 600, 900, 1000) according to claim 1.
